(19) United States
(12) Patent Application Publication
(10) Pub. No.: US 2025/0050576 A1
(43) Pub. Date: Feb. 13, 2025

(54) Three-Dimensional Printer System with Passive Fiber Aligning Nozzle

(71) Applicant: WiSys Technology Foundation, Inc., Madison, WI (US)

(72) Inventors: Gokul Gopalakrishnan, Platteville, WI (US); John Obielodan, Platteville, WI (US)

(21) Appl. No.: 18/796,821

(22) Filed: Aug. 7, 2024

Related U.S. Application Data
(60) Provisional application No. 63/531,182, filed on Aug. 7, 2023.

(51) Int. Cl. B29C 64/209; B29C 64/106; B29K 105/18; B33Y 30/00; B33Y 40/00

(52) U.S. Cl. CPC B29C 64/209; B29C 64/106; B33Y 30/00; B33Y 40/00; B29K 2105/18

(57) ABSTRACT

A three-dimensional (3D) printer system includes a nozzle that can passively align fibers being deposited with resin while creating fiber-reinforced composite components. The nozzle may include a nozzle body with main bore that directs material axially through a nozzle body, toward an alignment duct that provides the nozzle's outlet. The alignment duct may provide a passage in which the fibers are urged into a different orientation aligns the fibers generally parallel to each other in a different direction than the axial flow direction through the nozzle. The alignment duct's passage may be radially asymmetric, such as a tapering rectangular slot(s), which may provide guide surfaces to impart the reorientation of the flowing fibers.

### CROSS REFERENCE TO RELATED APPLICATION

This application claims the benefit of U.S. provisional application 63/531,182 filed Aug. 7, 2023 and hereby incorporated by reference.

### STATEMENT REGARDING FEDERALLY SPONSORED RESEARCH OR DEVELOPMENT

### FIELD OF THE INVENTION

The invention relates generally to additive manufacturing and, in particular, to a nozzle used with a three-dimensional (3D) printer to passively align discontinuous fibers to create components made from fiber reinforced composite materials with enhanced structural, thermal, and/or electrical properties.

### BACKGROUND OF THE INVENTION

Previously, 3D printing technologies have been implemented primarily for prototyping tasks. More recently, efforts have been made to additionally utilize 3D printing as commercially viable manufacturing systems.

Materials used in manufacturing or production-type implementations of 3D printed components are also evolving. Current efforts include using various fibrous material constituents along with resins during, for example, fused filament fabrication (FFF) 3D printing to create components from the fiber-reinforced composite materials. Compared to non-reinforced resin materials, these fiber-reinforced materials tend to provide enhanced strength and other materials characteristics that can be beneficial, especially in production components.

The improved performance of at least some of characteristics of fiber-reinforced materials can vary as a function of fiber orientation, such as the orientation of fibers relative to each other and/or various component features. When the fibers are implemented as short-stranded or other discontinuous fibers, performance characteristics such as strength, stiffness, electrical conductivity, and thermal conductivity can have greater values in direction(s) that are parallel to fiber orientation. Accordingly, the performance characteristics can typically be enhanced by improving fiber alignment.

However, controlling fiber alignment during 3D printing presents numerous challenges. Typical 3D printer nozzles have bores with circular cross-sections. These circular cross-sectional bores tend to release fibers for surface deposition with wavy or other non-linear flow patterns. Correspondingly, the short fibers extruded through the typical 3D printer nozzle tend to deposit with completely random fiber orientations in the printed component.

Various efforts have been made to control fiber alignment and orientation in FFF 3D printing. One attempt includes modifying the extrusion or print speed to exceed a critical speed and utilize inertial focusing as a function of shear gradients to provide some fiber alignment. However, such high-speed deposition may be incompatible with other aspects of particular 3D printing procedures, which are typically closely controlled. Furthermore, the fiber alignment using these high-speed deposition techniques only aligns the fibers in the deposit direction. However, the deposit direction may not correspond to the desired fiber orientation, based on particular design considerations of the component.

Other attempts to control fiber alignment include implementing specialized equipment. This includes auxiliary or modified system components that can impart, for example, rotational or reciprocating motion that can be actively controlled to influence fiber orientation. However, such specialized equipment can be expensive and require sophisticated control methodologies.

### SUMMARY OF THE INVENTION

The present inventors have identified a need to control fiber alignment in 3D printing composite materials in a more straightforward manner. They have developed a 3D printer nozzle that passively aligns fibers toward a particular orientation during deposition or writing, eliminating the need for highly specialized 3D printer components to orient fibers in a non-deposition direction.

Specifically, according to one aspect of the invention, a 3D printer nozzle is provided that may include an outlet end that presents guide surfaces that create preferential movement of fibers toward a target alignment orientation while the fibers travel through the outlet. The guide surfaces may be defined within an alignment duct that defines a passage with a different cross-sectional configuration than that of an upstream nozzle bore. The alignment duct's passage(s) may be radially asymmetric, such as a tapering rectangular slot(s).

It is thus a feature of at least one embodiment of the invention to provide a 3D printer system with a nozzle that can passively align fibers as the fibers exit the nozzle during an extruding or writing procedure. By passively aligning the fibers, a target fiber orientation may be provided while operating at a normal operating speed and without implementing any orientation-influencing actuators or other active specialized devices.

In accordance with another aspect of the invention, the alignment duct may be provided as a chip with two or more parallel tapering rectangular slots. The slot lengths may be longer than the average length of fibers being extruded in the composite material and the slot widths may be narrower than the averages fiber length. By providing slot dimensions that relate to scaled-up dimensions of the fibers, and with wider opening at inlets of the slots, the fibers tend to mechanically reorient to conform to the orientation(s) of the slots while passing through the chip.

It is thus a feature of at least one embodiment of the invention to provide a nozzle that provides passage ways that induce passive reorientation of fibers to provide substantial fiber alignment as a function of slot direction independent of writing or printing direction.

In accordance with another aspect of the invention, the chip or alignment duct may be removably mounted to the nozzle with a duct housing that may be removably connected to the nozzle. The duct housing may fully receive a portion of the nozzle in it to sandwich the alignment duct face-to-face between an annular face at the end of the nozzle and the duct housing. The duct housing may partially receive a portion of the nozzle in it to axially space the alignment duct from the nozzle's annular face and provide a collection chamber as a space bounded by respective surfaces of the nozzle, the alignment duct, and the duct housing.

It is thus a feature of at least one embodiment of the invention to provide fiber alignment aids that are interchangeable to provide different alignment characteristics and performance based on particular characteristics of the fibers within the filaments being extruded.

In accordance with another aspect of the invention, a thermal pathway may be defined between the nozzle, the alignment duct, and the duct housing to direct heat from the nozzle to the alignment duct. The heat may originate in the extruder head and be conducted through the nozzle so that no additional heat source is required to heat the duct housing and alignment duct.

It is thus a feature of at least one embodiment of the invention to control and maintain heating of the alignment duct to ensure maintaining melting temperatures of the composite material(s) flowing through the alignment duct.

These and other features and aspects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the scope of the invention.

### BRIEF DESCRIPTION OF THE DRA WINGS

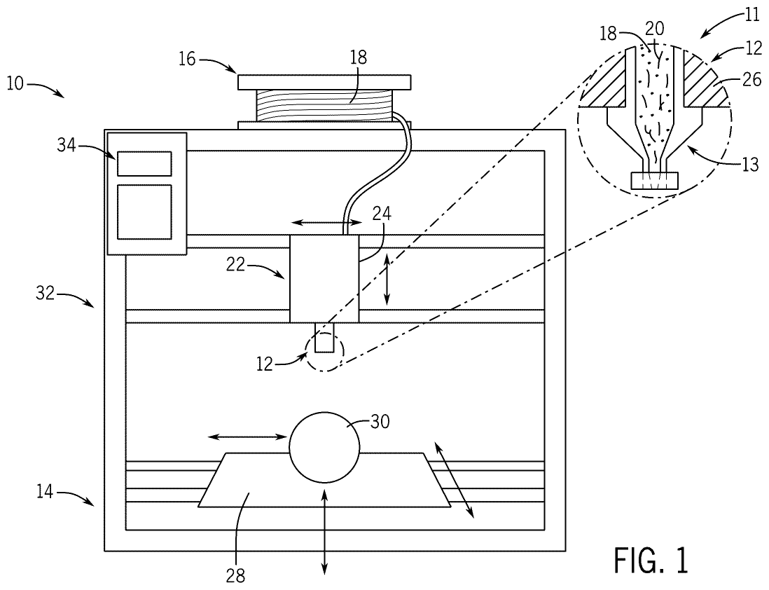

FIG. 1 is a simplified illustration of a front elevation of a three-dimensional (3D) printer system;

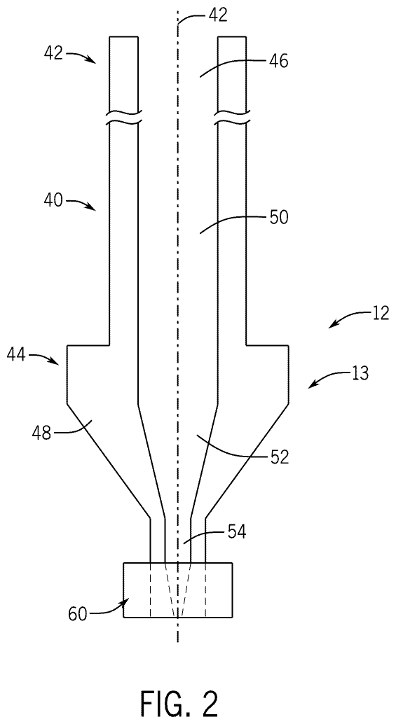

FIG. 2 is a cross-sectional side elevation view of components of a passive fiber alignment system;

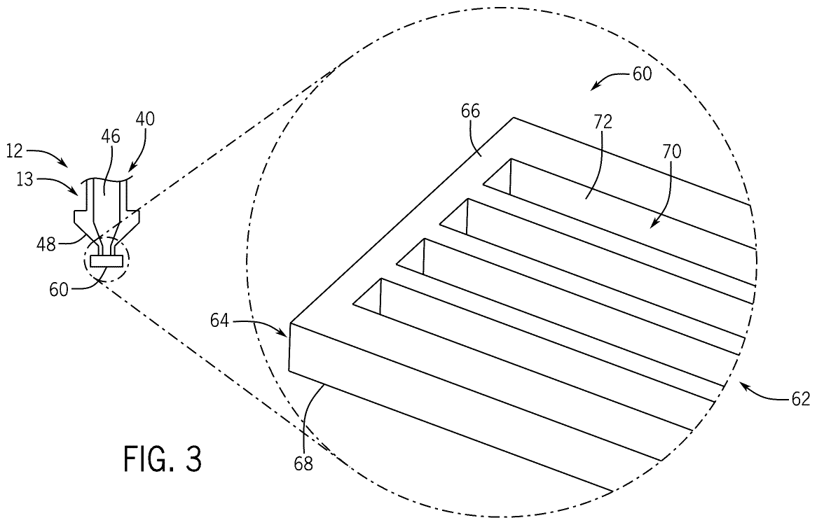

FIG. 3 is cross-sectional side elevation of portion of a passive fiber aligning nozzle assembly with a close-up pictorial view of a portion of an alignment duct 60;

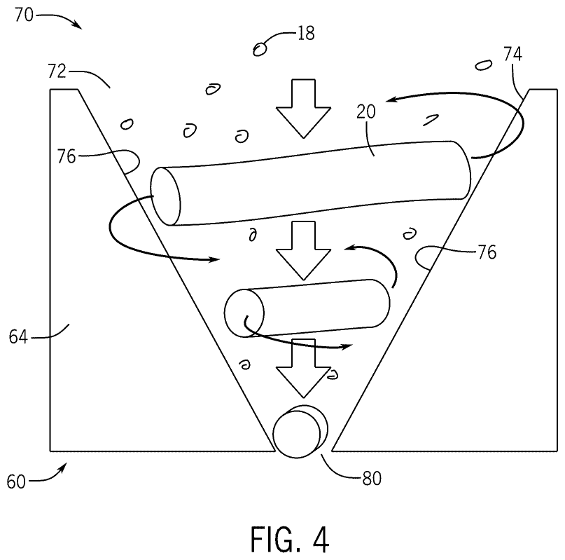

FIG. 4 is a schematic representation of cross-sectional view of an alignment duct's duct passage;

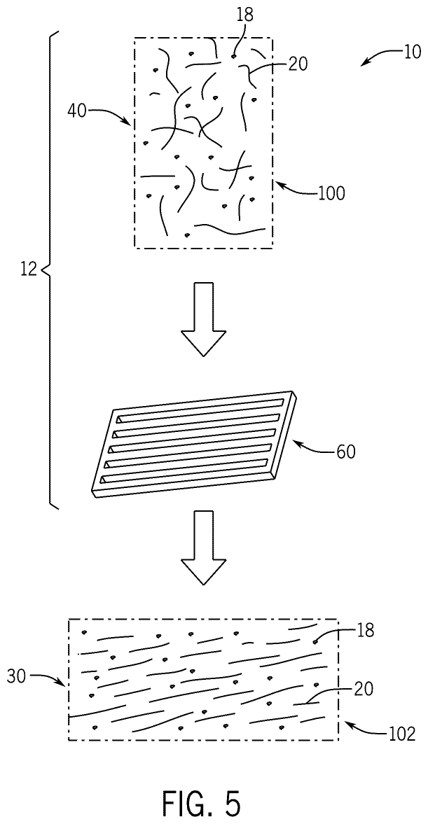

FIG. 5 is a schematic representation of fiber reorientation through an alignment duct;

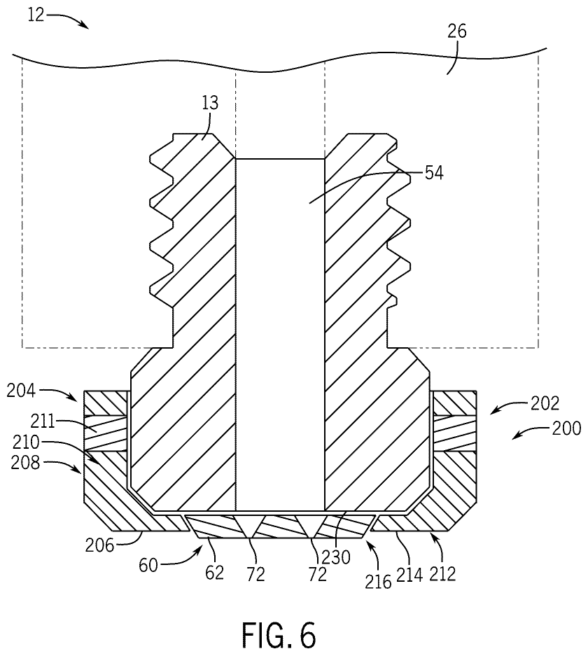

FIG. 6 is close-up cross-sectional view of portions of a nozzle assembly;

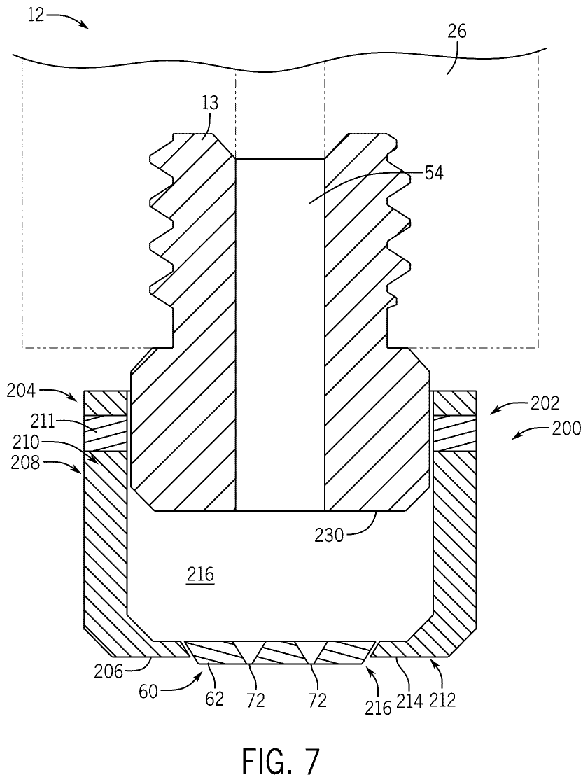

FIG. 7 is a close-up cross-sectional view of portions of a variant of the nozzle assembly of FIG. 6; and

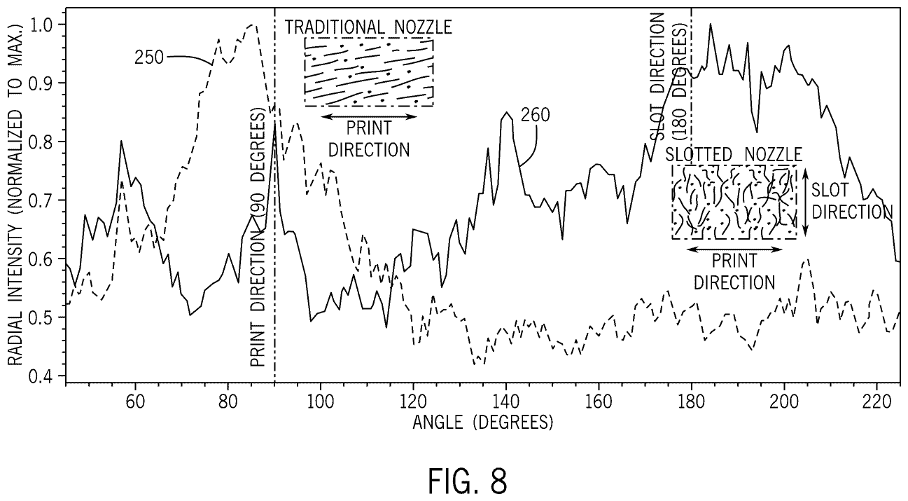

FIG. 8 is graph showing distributions of fiber orientation relative to print direction.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE PREFERRED EMBODIMENTS

Referring now to the drawings and initially to FIG. 1, a three-dimensional (3D) printer system that is shown as 3D printer 10 that incorporates a passive fiber alignment system 11 with a passive fiber aligning nozzle assembly 12. Nozzle assembly 12 includes nozzle 13 that is configured to align fibers toward a target orientation while extruding fiber-reinforce material in an additive manufacturing procedure, such as fused filament fabrication (FFF), fused deposition modeling (FDM), or fused pellets fabrication (FPF) procedures.

Still referring to FIG. 1, 3D printer 10 includes frame 14 that is formed from interconnected structural components, which are typically metallic tubes or solid extrusions. A spool 16 of composite thermoplastic material that typically includes a resinous material component and a fibrous material component is represented as thermoplastic material 18 is shown supported at the top of frame 14, which is fed to a printer extruder 20. The thermoplastic material 18 is shown here as an elongate filament or flexible columnar form of, for example ABS, PLA, PETG, Nylon etc., may be infused with or otherwise incorporate a fibrous material. The fibrous material may be short strands of fiber or small fibers 20 from, for example, glass fibers, carbon fibers, Kevlar™ fibers, polymer fibers, metal fibers or the like, for example between 0.2 and 10 mm long and more specifically 0.05-2 mm in length and may have an aspect ratio (length: diameter) of 20:1-200:1 commonly being 40-60:1. When the fibers are infused or otherwise incorporated generally longitudinally or axially into a filament that will be melted during extrusion, they may preferentially and automatically be reoriented perpendicularly to their previous orientation to a different orientation that corresponds to features of the passive fiber aligning nozzle assembly 12 in preference over the deposition direction that would otherwise occur. The elongate filament may have a diameter from 1 to 3 mm and generally no less and desirably at least 1.5 times the average fiber length. Although the composite material with its resinous or thermoplastic material component and fibrous material component are shown in an elongate spooled form, it is understood that other forms of feed materials are included. The composite material and/or its components include other forms such as pellets, powders, and/or liquid resins, including those that can be converted to solids using various suitable known techniques and/or other implementations with liquid resin systems.

Still referring to FIG. 1, extruder 22 defines a “hot end” of the printer 10 and includes extruder head 24 that has a heater that melts the thermoplastic material 18 and delivers the melted material to be extruded through nozzle assembly 12. Typically, the heater is implemented as a heating element that is mounted in a heater block, shown as heater block 26. The heater block 26 typically also supports other cooperating components for heating and monitoring or control, such as a thermistor or other temperature sensor, a heat sink, and provides the mounting structure to which nozzle 13 is attached and which provides a thermal transfer path for transmitting heat generated by the heating element to nozzle 13. Extruded material 18 is delivered or deposited onto deposition plate 28, which supports the additively created or growing 3D printed object, shown as component 30. Position control system 32 includes various actuators to provide movement to the extruder head 24 and/or deposition plate 28 for positioning the nozzle assembly 12 and component 30 relative to each other to create the 3D form of component 30. Control system 34 is operably connected to position control system 32. Control system 34 may include, for example, a computer which may be an industrial computer or, for example, a PLC (programmable logic controller), along with corresponding software and suitable memory for storing such software and hardware including interconnecting conductors for power and signal transmission between components of the position control system 32. The computer(s) of control system 34 executes various stored programs while receiving inputs from and sending commands to various components of position control system 32 to provide controls that correspond to depositing material 18 to create the component 30.

Referring now to FIG. 2, nozzle 13 includes nozzle body 40 that extends along a nozzle body axis 42 generally perpendicularly away from a bottom surface of extruder head 24 (FIG. 1). Nozzle body 40 has an upstream or inlet end 44 that is connected to and receives the material 18 (FIG. 1) from extruder head 24 (FIG. 1) and a downstream or outlet end 46. Nozzle bore 46 extends axially through nozzle body 40, along the nozzle body axis 42 and will generally match or be smaller than a diameter of the filament. At the nozzle's outlet end 46, a nozzle tip 48 may be provided that defines downstream segments of the nozzle bore 46. As shown here, nozzle bore 46 may include a main nozzle bore segment 50, a tapering nozzle bore segment 52, and an outlet nozzle bore segment 54. Within nozzle bore 46, main nozzle bore segment 50 has the largest diameter, outlet nozzle bore segment 54 has the smallest diameter, and tapering nozzle bore segment 52 has a variable diameter along its length, conically tapering down from the main nozzle bore segment 50 to the outlet nozzle bore segment 54. Each of the main, tapering, and outlet nozzle bore segment 50, 52, 54 has a circular cross-section and these segments are axially aligned with each other are collectively aligned with the nozzle body axis 42. While flowing through the nozzle body 40, the fibers 20 (FIG. 1) may flow with random orientations, such as during relatively deposit rates. When flowing at a sufficiently fast deposit rate, the fibers 20 (FIG. 1) may align generally parallel to each other in a direction that corresponds to the nozzle flow direction, which is parallel to the nozzle body axis 42. Regardless, of the particular orientation of the fibers 20 (FIG. 1) while flowing through the nozzle bore 46, after flowing out of nozzle tip 48, they are passively reoriented in an alignment duct 60 toward the target orientation and alignment.

Referring now to FIG. 3, alignment duct 60 is shown here in the form of aligner chip 62 with chip body 64 that is generally planar and is mounted to the end of nozzle tip 48, perpendicular to nozzle body axis 42 (FIG. 2). Chip body 64 has an upper surface 66 that faces toward nozzle tip 48 and lower surface 68 that faces away from nozzle tip 48. and lower surfaces 66, 68. Multiple duct passages 70 extend through the thickness of chip body 64, shown here arranged generally parallel to each other. The duct passages 70 provide openings with different cross-sectional configurations than those of the nozzle bore 46. Typically, the duct passages 70 are radially asymmetric, shown here as being defined by rectangular tapering slots 72. Rectangular tapering slots typically provide a rectangular slot inlet and a rectangular slot outlet at respective upstream and downstream positions of the alignment duct 60. Each of the slot inlet and slot outlet typically defines a rectangular perimeter shape with respectively viewed from top and bottom elevations. The rectangular slot inlet is typically wider, for example at least 2-times, or 3-times, or 4-times, or 5-times wider and may be between about 6-times and 10-times wider than the slot outlet width. Each rectangular slot may have slot inlet length that is typically the same length or longer than the slot outlet length. As shown in FIG. 3, a set of tapering slots 72 may be provided through the aligner chip 62. Typically, each of the tapering slots 72 is arranged parallel to the other slots 72. The aligner chip 62 may be made by utilizing various semiconductor fabrication techniques that are used for manufacturing microelectromechanical systems using silicon as its raw material(s). For example, the aligner chip 62 may be made from a single-crystal silicon wafer using photolithography and bulk micromachining, such as using an anisotropic etching process and various photomasks, to form it and its various features. It is contemplated that the aligner chip 62 may be further supported at least in part by a metallic plate or sleeve that may facilitate mounting the aligner chip 62 to the nozzle tip 48.

Referring now to FIG. 4, tapering slots 72 provide surfaces 74 that are arranged to impart movement of the fibers 20 to urge them into a target orientation that generally aligns the fibers 20 with respect to each other, such as near parallel orientations. The surfaces 74 are shown defined at angled inner walls 76 that define the tapering slots 72. As the material 18 and its entrained fibers 20 flow through the chip body 64, the fibers collide with the inner walls 76 and deflect by rotating while advancing in the flow direction until the width dimension of the fibers 20 are oriented to correspond to the width dimension of the slot's outlet 80.

In one nonlimiting example, the width of the slot 72 will be less than the length of the filaments and desirably less than two times the diameter of the filaments or in some embodiments less than three times the diameter of the filaments or less than ten times the diameter of the filaments with the length of the slot being at least an average length of the filaments and typically no less than 1.5-times the length of the filaments and in some cases at least twice the length of the filaments and in some cases less than 10-times the length of the average filament length. The slope of the walls leading to the slot will typically provide an included angle of less than 45° and in some cases less than 30°. The rectangular openings at the chip lower surface's slot outlets have lengths that are typically between 0.25 mm to 3.0 mm long, such as 0.3 mm, or 0.4 mm, or 0.5 mm, to 1 mm, or 1.5 mm, or 2.0 mm, or 2.5 mm, or 3.0 mm long. The rectangular openings at the chip lower surface's slot outlets have widths that are typically between 0.02 mm to 0.4 mm wide, such as 0.02 mm, or 0.03 mm, or 0.04 mm, or 0.05 mm to 0.1 mm, or 0.15 mm, or 0.2 mm, or 0.25 mm, or 0.3 mm, or 0.35 mm, or 0.4 mm, or 0.45 mm, or 0.50 mm wide.

Referring now to FIG. 5, during a 3D printing procedure, when the material 18 flows through nozzle body 40, its entrained fibers 20 can define a random collective orientation, shown as first orientation 100. It is understood that, for example, if the flow rate through nozzle body 40 is sufficiently high, then the fibers 20 may at least partially align with each other in the nozzle flow direction as the first orientation while flowing through nozzle body 40. In the alignment duct 60, the fibers 20 passively change their orientation by their interactions with the various surfaces of the alignment duct 60. The material 18 and its reoriented fibers 20 flow out of the alignment duct 60 are deposited onto the component 30 in a second orientation 102. The second orientation defines a deposition alignment in which the fibers 20 are aligned generally parallel to each other in a direction that is different than the nozzle flow direction. The alignment of the fibers 20 with respect to each other in the deposition alignment of component 30 may provide fibers that are aligned to a mean angle of less than 30-degrees, typically less than 20-degrees, and more typically about 15-degrees or less, when compared to the target orientation or alignment.

Referring generally to FIGS. 6 and 7, nozzle assembly 12 is shown having alignment duct housing 200 that secures alignment duct 60 with respect to nozzle body 40. Alignment duct housing 200 has a housing body 202 that defines nozzle-engaging portion 204 and duct-engaging portion 206. Housing body 202 is shown with a cup-like form with a housing base 208 that provides a circumferential sidewall or collar 210 that is sized to engage and hold itself against the outlet end of nozzle 13, for example, by way of a friction fit. Housing base 208 is shown fitting concentrically over nozzle 13 and may include knurling 211 or other features to enhance engagement between duct housing 200 and nozzle 13. Housing flange 212 is attached to and extends radially inward from housing base 208 and provides a bottom wall of housing body 202. Housing flange 212 includes seat 214 with an opening 216 that receives and holds alignment duct 60. Aligner chip 62 and seat 214 have cooperating dimensions and features that engage each other to secure aligner chip 62 into seat 214. Such features are represented here as corresponding tapered or beveled surfaces of the aligner chip's 62 outer periphery and seat's 214 inner periphery that allow the aligner chip 62 to nest or friction fit into and be retained by the seat 214.

Referring now to FIG. 6, alignment duct housing 200 is configured to receive nozzle 13 into its full axial length or height dimension. This provides a sandwiching of chip 62 between nozzle 13 and housing flange 212. Tapering slots 72 directly receive material from the composite material including filaments or fibers 20 (FIG. 1) in this arrangement.

Referring now to FIG. 7, this alignment duct housing 200 is configured to receive nozzle 13 only partially into its axial length or height dimension. Nozzle 13 is shown here inserted less than halfway into duct housing 200. This provides an axially spaced relationship between chip 62 and nozzle 13. Collection chamber 216 is provided by a space defined lengthwise or axially between an end face of nozzle 13 and housing flange 212, and widthwise or radially by the housing base 208 or collar 210.

Referring again to FIGS. 6 and 7, nozzle 13 defines a nozzle outlet face 230 that is generally planar and annularly defined between an OD (outside diameter) and ID (inside diameter) of the nozzle's 13 outlet end. As shown here, nozzle outlet face 230 may have a face width or diameter that is defined between the nozzle face OD and ID and is wider than the nozzle face ID and thus the opening of bore segment 54. Bore segment 54 is shown here with a constant diameter along its length.

Still referring to FIGS. 6 and 7, the sandwiched-chip arrangement of FIG. 6 is typically implemented with delivery of filament with randomly oriented short-fibers. The spaced-chip arrangement with collection chamber 216 of FIG. 7 is typically implemented with delivery of filament fibers that are pre-aligned along the filament axis direction, whereby the collection chamber 216 provides sufficient space and time for the fibers to reorient away from vertical or away from the typically lengthwise or axial pre-alignment orientations.

Still referring to FIGS. 6 and 7, alignment duct housing 200 is typically made from a metallic material with sufficient thermal conductivity to provide a thermal pathway between the nozzle 13 and the alignment duct 60 to suitably maintain a target temperature of the alignment duct 60 use of the 3D printer 10 (FIG. 1). The target temperature of alignment duct 60 is sufficient to prevent the duct's 60 cooling to an extent that may create a gumming condition or otherwise compromise flow through the duct 60. Alignment duct housing 200 is typically made from a material with thermal conductivity characteristics that are at least as conductive as those of nozzle 13. Nozzle 13 and alignment duct housing 200 may be made from the same material(s), such as brass, stainless steel, or copper, or the alignment duct housing 200 may be made from a material that is a better heat conductor than nozzle 13.

Referring now to FIG. 8, this graph shows a performance comparison of a conventional or traditional nozzle(s) to a nozzle(s) 13 implementing an alignment duct 60 with tapered slots 72. The dashed-data line 250 plots the values for the traditional nozzle(s) and the solid-data line 260 plots the values for the nozzle(s) implementing an alignment duct 60 with tapered slots 72. The graph shows that when 3D printing with traditional radially symmetric nozzles, fibers tend to align with the write or print direction. However, independent control over fiber orientation is achieved with the nozzle 13 and alignment duct 60 with tapered slots 72 that decouple fiber orientation from write or print direction. Instead, fiber alignment with the nozzle 13 and alignment duct 60 with tapered slots 72 is controlled as a function of slot direction or orientation.

Other aspects and characteristics of a 3D printing system with a passive fiber aligning nozzle falling within the scope of the present invention are disclosed in the drawings attached hereto, the disclosure of which is expressly incorporated herein.

Many changes and modifications could be made to the invention without departing from the spirit thereof. The scope of these changes will become apparent from the appended claims.

What is claimed is:

1. A three-dimensional (3D) printer system for creating components from a composite material that includes a resinous material and a fibrous material, comprising:
a 3D printer that includes:
a positioning system configured to control deposition location of the composite material;
a nozzle assembly that is moved by the positioning system and is configured to deposit the composite material, the nozzle assembly including:
a nozzle that defines a nozzle body having:
an inlet end;
an outlet end;
a nozzle bore that extends axially through the nozzle body to convey the composite material from the inlet end to the outlet end;
an alignment duct aligned with the nozzle bore and providing a duct passage with a different cross-sectional shape than a cross-sectional shape of the nozzle bore.

2. The system of claim 1, the alignment duct comprising an aligner chip with a chip body that lies in a plane that is generally perpendicular to nozzle bore, and wherein the alignment duct:
extends through the chip body; and
defines a tapering profile when viewed in cross-section.

3. The system of claim 1, wherein:
the fibrous material comprises discrete filaments with each filament defining a length and a diameter;
the alignment duct defines a tapering slot with a length and a width;
the slot width is less than the filament length to urge the filaments to orient the filament so the filament length generally aligns with the slot length while passing through the alignment duct.

4. The system of claim 3, wherein:
the slot width is less than ten times the filament diameter.

5. The system of claim 3, wherein the alignment duct:
includes a pair of angled inner walls that is defined between a slot inlet and a slot outlet, and
the slot inlet is at least 2-times wider than the slot outlet.

6. The system of claim 5, wherein:
the length of the alignment duct is less than 10-time an average filament length of the fibers of the fibrous material.

7. The system of claim 3, wherein:
the tapering slot is one of multiple tapering slots that extend through the alignment duct;
each tapering slot is arranged parallel to the other ones of the multiple tapering slots.

8. The system of claim 3, the nozzle assembly further comprising:
an alignment duct housing that secures the alignment duct with respect to the nozzle.

9. The system of claim 8, wherein the alignment duct housing defines:
a nozzle-engaging portion that mounts the alignment duct housing to the nozzle; and
a duct-engagement portion that mounts the alignment duct to the alignment duct housing.

10. The system of claim 9, wherein the duct housing comprises:
a housing base that engages the nozzle; and
a housing flange that is attached to the housing base and supports the alignment duct.

11. The system of claim 10, wherein:
the housing base includes a collar concentrically engages a lower end of the nozzle; and
the housing flange includes a seat with an opening in which the alignment duct is held.

12. The system of claim 11, wherein the nozzle defines a nozzle outlet face that is:
generally planar;
defined at the nozzle lower end; and
faces the alignment duct.

13. The system of claim 12, wherein:
the housing flange holds the alignment duct in face-to-face engagement with the nozzle outlet face.

14. The system of claim 12, wherein:
the housing flange holds the alignment duct axially spaced from the nozzle outlet face.

15. The system of claim 14, wherein the nozzle assembly further comprises:
a collection chamber defined as a space between:
the nozzle outlet face;
the housing flange; and
the housing base.

16. A nozzle assembly for a three-dimensional (3D) printer, the nozzle assembly comprising:
a nozzle that defines a nozzle body;
a nozzle bore that extends axially through the nozzle body and defines a circular cross-sectional area;
an alignment duct that is positioned to receive a composite material having fibers from the nozzle bore;
wherein:
the alignment duct provides a passage with a non-circular cross-sectional area and at least one surfaces that is arranged to impart movement of the fibers to guide the fibers into parallel alignment with each other while flowing through the alignment duct.

17. The nozzle assembly of claim 16, further comprising an alignment duct housing, and wherein the alignment duct housing:
secures the alignment duct with respect to the nozzle; and
provides a thermal pathway between the nozzle and the alignment duct to maintain a temperature of the alignment duct during use of the 3D printer.

18. The nozzle assembly of claim 16, wherein:
the nozzle defines a nozzle outlet face that is generally planar and annularly defined between an OD (outside diameter) and ID (inside diameter) of an outlet end of the nozzle,
the nozzle outlet face defines a face width as a distance between the nozzle face OD and ID,
the face width is greater than the nozzle face ID,
the alignment duct defines a width that is great than the nozzle face ID and less than the nozzle face OD.

19. A method of aligning fibers in a composite material while three-dimensional (3D) printing, the method comprising:
delivering a molten resin and fibers through a nozzle body in nozzle flow direction toward an alignment duct,
wherein the fibers flow through the nozzle with a first orientation that defines either a random orientation or a nozzle-body fiber alignment in which the fibers are aligned generally parallel to each other in a direction that corresponds to the nozzle flow direction; and
passively changing the orientation of the fibers in the alignment duct to a second orientation that defines a deposition alignment in which the fibers are aligned generally parallel to each other in a direction that is different than the nozzle flow direction.
